(19) United States
(12) Patent Application Publication
(10) Pub. No.: US 2021/0078652 A1
(43) Pub. Date: Mar. 18, 2021

(54) COVERING PART FOR A CHASSIS ELEMENT OF A MOTOR VEHICLE

(71) Applicant: AUDI AG, Ingolstdt (DE)

(72) Inventor: Bastian BÖSL, Garching (DE)

(73) Assignee: AUDI AG, Ingolstadt (DE)

(21) Appl. No.: 16/629,685

(22) PCT Filed: Jul. 27, 2018
(86) PCT No.: PCT/EP2018/070448

§ 371 Date: Jan. 9, 2020

(30) Foreign Application Priority Data
Aug. 21, 2017 (DE) 10 2017 214 492.0

(51) Int. Cl. B62D 35/02; B60G 7/00

(52) U.S. Cl. CPC B62D 35/02; B60G 2204/4308; B60G 2204/20; B60G 7/001

(57) ABSTRACT

A covering element for a chassis element of a motor vehicle, comprising a covering surface, which covers at least a part of the chassis element, and a first fastening section, which extends from the surface of the covering element to the chassis element and has receptacles for fasteners. The disclosure includes a covering element has an opening that enables access to a first fastening section.

The invention relates to a covering part for a chassis element of a motor vehicle, of the type specified in the preamble of claim 1.

As soon as a motor vehicle begins to move, countless air vortices are created. Particular aerodynamic problem zones include the area around the wheel suspension and the underside of a motor vehicle. In modern motor vehicles, portions of both the undersides and the suspension arms, which are part of the wheel suspension, are provided with specially designed covers to achieve better air flow around the underbody and the wheels. Improved aerodynamics reduces a motor vehicle's fuel consumption and its noise level, among other things. Such covers also provide protection against stone impacts and damage when driving over obstacles.

U.S. Pat. No. 7,654,544, for example, proposes a covering part for a suspension arm having a downwardly open hollow profile. The pi-shaped cross-section of the suspension arm enables the covering part to be attached in a force-fitting and form-fitting manner to the outer sides of the arm.

DE 10 2013 006 253 A1 discloses a cover for a suspension arm, which has a receptacle for a fastening means configured as a rivet or screw. Attaching the cover with screws enables, for example, a releasable attachment to the suspension arm. Because the cover, which is made of plastic, will not enable sufficient tightening torque to be established, a metallic sleeve is used for the receptacle. To secure the sleeve in the receptacle, the ends of the sleeve can be flanged.

DE 10 2014 003 305 A1 describes a generic cover that can be fastened to a suspension arm by means of mounting clips. Since an air guiding element prevents access to the side that faces forward in the direction of travel, the cover can be attached to the suspension arm on only one side by means of mounting clips. The complex geometry of the protruding fastening sections requires a precise installation sequence of the cover. Additionally, the shape of the cover is precisely matched to the shape of the suspension arm.

The object of the invention is to develop a cover for a chassis element of the type specified in the preamble of claim 1 such that a simple and secure mounting of the cover is ensured.

This object is attained by the characterizing features of claim 1 in combination with the features of its preamble.

The dependent claims specify advantageous developments of the invention.

In a known manner, a covering element for a chassis element, in particular for a suspension arm, comprises a covering surface having at least one fastening section, which extends from the covering surface to the suspension arm, and an upwardly-curved wall at the front in the direction of travel. The distal fastening section and the suspension arm have receptacles for fasteners, by means of which the covering element is attached to the underside of the suspension arm. The upwardly-curved wall at the front in the direction of travel improves aerodynamics and also protects against stone impacts. However, it restricts access to the suspension arm and to the fastening section, so that the fasteners can be attached on only one side.

According to the invention, the covering element has at least one opening, which enables access to the at least one fastening section that is formed from the surface of the covering element to the suspension arm. The fastening section is arranged such that, when installed, it extends along one of the limbs of the suspension arm in the longitudinal direction of the arm. The configuration of the covering element according to the invention enables easy access to the distal fastening section by means of the opening. In particular, access to the limb that faces forward in the direction of travel, which is otherwise inaccessible due to the upwardly curved wall, is also guaranteed. This advantageously enables the covering element to be fastened to both limbs of the suspension arm. This embodiment of the invention ensures a particularly easy mounting of the covering element, but one that is also secure. Another advantage is the higher degree of freedom in terms of axial and lateral adjustment of the covering element, so that one shape of covering element can be installed on various suspension arms of different geometries, e.g. different widths.

A preferred embodiment provides that the covering element has a second fastening section, the opening formed in the covering element being positioned between the two fastening sections and ensuring access to both fastening sections in a particularly simple manner.

The opening of the covering element is preferably configured as a rectangle. This embodiment not only enables particularly easy access to the opening, but also offers the option of using any side of the rectangle to form a hinge.

A preferred embodiment of the invention provides that the opening in the cover can be closed by means of a flap. This not only ensures the aerodynamics of the covering part, but protects the suspension arm from damage over the entire length of the cover.

The flap is preferably configured as an integral component of the covering element, the entire covering element preferably being made of plastic. The advantages of this embodiment are not only easier handling of a single element, but also very simple and inexpensive production, for example as an integral injection molded part. A further advantage is that the flap is well fastened and securely attached.

The flap is preferably integrated in the covering element by means of a film hinge made of the same material. In combination with the rectangular shape of the opening, a certain hinge length that ensures the functionality of the film hinge is enabled. Film hinges enable complete parts to be easily produced, e.g. in a single injection molding process. It is conceivable for the flap to be fixed to the opening by means of one or more click-lock mechanisms. Overall, this embodiment of the invention enables particularly easy handling and mounting. Further advantages of this embodiment include a reduction in the number of individual parts, simplified logistics, guaranteed security against detachment, and a decrease in the time required for assembly and fitting during mounting.

A preferred embodiment provides that the first and second fastening sections are spaced apart from one another transversely to the longitudinal axis of the arm, so that they are arranged in more or less parallel planes, with the opening being formed in the space between the two fastening sections.

In the installed state, the fastening sections are arranged on the outer side and/or on the inner side of the limbs of the suspension arm. This enables both limbs to advantageously serve as connection points for connecting the covering element to the suspension arm. Both the fastening sections and the limbs of the suspension arm have receptacles for fasteners. Fastening can be accomplished by means of mounting clips, for example, which are an inexpensive variant and ensure easy handling. Advantages of this embodiment are not only the ease of mounting of the covering element, but also that it is fastened to both limbs of the suspension arm, guaranteeing a secure mounting. Furthermore, the simple geometry of the distal fastening sections enables increased axial and lateral freedom in mounting the covering element. The resulting advantage is a variable adaptation of the covering element to different variants of a suspension arm, e.g. having different widths.

In addition to the variable size of the opening in the covering element, it is also conceivable for the number of openings to vary. It is further conceivable for both the length of the fastening sections and their number to be variable. These various possible embodiments enable a diverse combination of openings and their associated fastening sections. This in turn ensures easy mounting and a secure attachment of the covering element.

According to a further preferred embodiment of the invention, the covering element, the flap, and the fastening sections are formed from a single pressed part, e.g. as an integral injection molded part. The advantages of an integral configuration of the covering element are a simple and inexpensive production, easier handling of the parts during logistics and mounting, and an effective and secure fastening of the integral element, especially on rough roads.

Further advantages and possible applications of the present invention will be apparent from the following description in conjunction with the exemplary embodiments depicted in the set of drawings.

In the drawings:

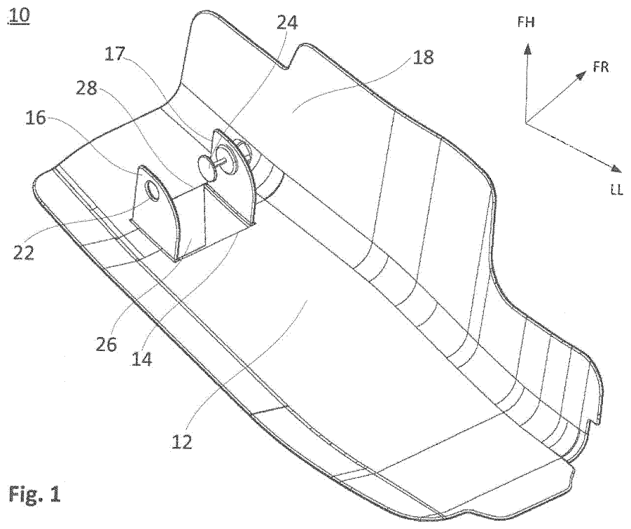

FIG. 1 is a lateral plan view of the covering element according to the invention;

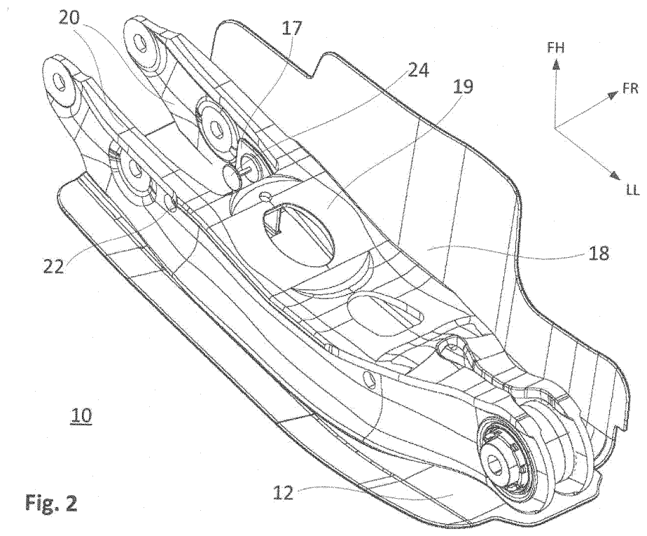

FIG. 2 shows the covering element of FIG. 1 mounted on the suspension arm; and

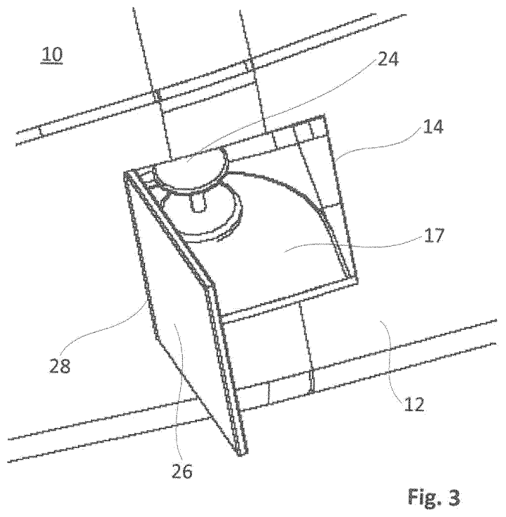

FIG. 3 is an enlarged view from below of the opening in the covering element of FIG. 1.

FIGS. 1 to 3 show schematic illustrations of a covering element, denoted as a whole by reference number 10, for a chassis element of a motor vehicle. In the present case, this is a covering element 10 for a suspension arm 19.

The covering element 10 comprises a substantially horizontally formed covering surface 12, an opening 14, and at least a first fastening section 16, which is configured extending upward from the covering surface 12 in the vertical direction of the vehicle FH. In the present case, a second fastening section 17 is formed, which is also accessible by means of the opening 14. The first fastening section 16 and the second fastening section 17 are spaced apart from one another transversely to the longitudinal direction of the arm LL and extend along the longitudinal direction of the arm LL.

As FIG. 1 and FIG. 2 show, in the direction of travel FR the cover is configured as having an upwardly curved wall 18 which inhibits access to the second fastening section 17. When installed, the two fastening sections 16, 17 extend along the limbs 20 of the suspension arm 19. The fastening sections 16, 17 may extend along the inner side and/or on the outer side of the limbs 20. Both the fastening sections 16, 17 and the limbs 20 of the suspension arm 19 have receptacles 22 for fasteners. In the present case, the covering element 10 is fastened to the limb 20 of the suspension arm 19 by means of a mounting clip 24.

The opening 14 of the covering element 10 is advantageously positioned between the first fastening section 16 and the second fastening section 17 and thereby enables easy access to both distal fastening sections 16, 17. Particularly advantageous is the access to the fastening section 17 that faces forward in the direction of travel FR and to the corresponding limb 20 of the suspension arm 19, both of which are made inaccessible by the upwardly curved wall 18. It is conceivable for both the size of the opening 14 and the number of openings 14 to be variable as desired, and also for the length and the number of the fastening sections 16, 17 to be variable.

The covering element 10 is preferably made of plastic and preferably has a rectangular opening 14 that can be closed by means of a flap 26. The flap 26 can be fixed to the opening 14 by means of a click-lock mechanism, which is not shown here for reasons of clarity. The flap 26 and the covering element 10 are preferably configured as an integral part, the flap 26 being integrated securely in the covering part 10 by means of a film hinge 28 made of the same material.

1-12. (canceled)

13. A covering element for a chassis element of a motor vehicle, comprising:
a covering surface, which covers at least a part of the chassis element, and at least a first fastening section, which extends from the surface of the covering element to the chassis element and has at least one receptacle for fasteners,
wherein the covering element has at least one opening by which the first fastening section is accessible.

14. The covering element according to claim 13, wherein the covering element has a second fastening section that is accessible by the opening.

15. The covering element according to claim 14, wherein the opening is formed between the first fastening section and the second fastening section.

16. The covering element according to claim 13, wherein the opening has a rectangular shape.

17. The covering element according to claim 13, wherein the opening can be closed by a flap.

18. The covering element according to claim 17, wherein the flap is configured as an integral component of the covering element.

19. The covering element according to claim 18, wherein the flap is integrated in the covering element by a film hinge made of the same material.

20. The covering element according to claim 14, wherein the first fastening section and the second fastening section are configured such that they are spaced apart from one another transversely to the longitudinal direction of the arm.

21. The covering element according to claim 14, wherein the first fastening section and the second fastening section are configured such that in the installed state they are arranged on the outer side and/or on the inner side of a respective one of the limbs of the suspension arm.

22. The covering element according to claim 13, wherein several openings with assigned first fastening sections and/or second fastening sections extend over the longitudinal direction of the arm.

23. The covering element according to claim 13, wherein the length of the opening or the length of the openings and the length of the first fastening section or the length of the first and the second fastening sections is variable.

24. The covering element according to claim 13, wherein the covering element, the flap, and the fastening section(s) are configured as an integral pressed part.

25. The covering element according to claim 14, wherein the opening has a rectangular shape.

26. The covering element according to claim 15, wherein the opening has a rectangular shape.

27. The covering element according to claim 14, wherein the opening can be closed by a flap.

28. The covering element according to claim 15, wherein the opening can be closed by a flap.

29. The covering element according to claim 16, wherein the opening can be closed by a flap.

30. The covering element according to claim 14, wherein several openings with assigned first fastening sections and/or second fastening sections extend over the longitudinal direction of the arm.

31. The covering element according to claim 15, wherein several openings with assigned first fastening sections and/or second fastening sections extend over the longitudinal direction of the arm.

32. The covering element according to claim 16, wherein several openings with assigned first fastening sections and/or second fastening sections extend over the longitudinal direction of the arm.
